(19) United States
(12) Patent Application Publication
(10) Pub. No.: US 2015/0231860 A1
(43) Pub. Date: Aug. 20, 2015

(54) Laminated Lead Composite and Method of Manufacturing

(71) Applicant: Vulcan GMS, Milwaukee, WI (US)

(72) Inventors: Paul H. Yanke, Oconomowoc, WI (US); Scott H. Yanke, Oconomowoc, WI (US)

(21) Appl. No.: 14/627,850

(22) Filed: Feb. 20, 2015

Related U.S. Application Data
(60) Provisional application No. 61/942,359, filed on Feb. 20, 2014.

(51) Int. Cl. B32B 15/08; B32B 37/18; B32B 37/12

(52) U.S. Cl. CPC B32B 15/08; B32B 37/12; B32B 37/18; B32B 2255/26; B32B 2255/06; B32B 2307/212; B32B 2571/00; B32B 2311/14; B32B 2037/1253

(57) ABSTRACT

A lead composite and method of manufacturing the same is disclosed for electromagnetic radiation shielding. The lead composite comprises at least one laminated surface, a base plate affixed to the lead plate; and a polymer coating material affixed to a surface of the lead plate.

### CROSS-REFERENCE TO RELATED APPLICATIONS

This application claims priority to U.S. provisional patent application Ser. No. 61/942,359, filed Feb. 20, 2014, the entire contents of which is incorporated herein by reference.

### BACKGROUND OF THE INVENTION

1. Technical Field

The present disclosure generally relates to a laminated lead composite and more particularly to a laminated lead composite for use in x-ray shielding and a method for making the same.

2. Background Art

Various types of electromagnetic radiation shielding have been developed for use in medical imaging applications and similar applications that also require electromagnetic radiation shielding. One such form of shielding includes the usage of lead. Lead is an effective shielding material due to its high density, i.e., relatively high atomic mass and small atomic radius, which absorbs and scatters various forms of electromagnetic radiation including x-rays. With recent improvements in the field of digital radiography, the digital sensors used to replace traditional photographic film are capable of producing x-ray images from a lower level of radiation emission. However, despite this reduction in radiation emitted from current medical imaging devices, the need to include shielding in such medical imaging devices remains.

Because lead is a relatively soft metal, i.e., weak or pliable, it is typically reinforced with another substrate to provide structural strength. For example lead may be adhesively bonded to an aluminum substrate in order to provide the structural or mechanical rigidity required for use in medical imaging devices. However, traditional shielding in which lead and an aluminum substrate are adhesively bound together has been known to exhibit shortcomings such as delaminating, or undesirable moving or creeping over a prolonged period of time. To address these undesirable shortcomings, in some applications lead is solely utilized to form the shielding, without the addition of a substrate to provide additional structural support. However, in these alternative applications, the lead must have an undesirably excessive thickness in order to provide the required structural strength, which would otherwise be provided by the substrate. In such applications, this increased lead thickness becomes prohibitive for many reasons, including weight, size and cost.

The present invention seeks to improve upon the prior art by providing a laminated lead based composite for use in radiations shielding with improved rigidity and strength.

### SUMMARY OF THE INVENTION

It is therefore an object of the present invention to provide a laminated lead composite element suitable for use in electromagnetic shielding and in particular in shielding for medical imaging instrumentation that will provide rigidity and strength to the shielding.

For the purposes of this specification, the term ‘comprise’ shall have an inclusive meaning. Thus it is understood that it should be taken to mean an inclusion of not only the listed components it directly references, but also non specified components. Accordingly, the term ‘comprise’ is to be attributable with as broad an interpretation as possible and this rationale should also be used when the terms ‘comprised’ and/or ‘comprising’ are used.

Further aspects or embodiments of the present invention will become apparent from the ensuing description which is given by way of example only.

In one embodiment of the invention, the present disclosure provides a laminated lead composite element suitable for use in electromagnetic shielding and in particular in shielding for medical imaging instrumentation that will maintain a consistent shape over a prolonged period of use.

In one embodiment of the invention, the present disclosure provides a laminated lead composite element comprising; a lead plate having a first and second surface, wherein at least one of the first and second surfaces of the lead plate is a laminated surface; a base plate affixed to the first surface of the lead plate; and a polymer coating material affixed to the second surface of the lead plate.

In one embodiment of the invention, the lead plate is configured to shield electromagnetic radiation omitted from a medical imaging instrumentation. In a further embodiment of the present invention the thickness of the lead plate to provide shielding of electromagnetic radiation omitted from a medical imaging instrumentation is between 0.01 inches and 0.1 inches.

In a further embodiment of the invention, the lead composite element also includes first and second adhesive layers, with the first adhesive layer located between the first surface of the lead plate and the base plate, and the second adhesive layer located between the second surface of the lead plate and the polymer coating material. In a further embodiment of the present invention, the first adhesive layer comprises a resin, such as an epoxy resin; and, the second adhesive layer comprises butanone, i.e., methyl ethyl ketone, and/or a resin such as an epoxy resin.

In a further embodiment of the invention, the lead composite element also includes one or more mounting structures such as apertures, threaded apertures, and/or outwardly extending tabs, which in use are configured to engage a portion of the electromagnetic radiation omitting device for providing electromagnetic radiation shielding thereto.

In yet another embodiment of the invention, the laminated lead composite element may comprise multiple layers of lead plate, base plate and/or polymer coating material.

The present disclosure also provides a method of making a reinforcing element comprising the steps of: laminating at least one of a first and second surface of a lead plate; affixing the first surface of the lead plate to a base plate; and affixing a polymer coating material to the second surface of the lead plate.

In a further embodiment of the invention, the present disclosure provides for the additional steps of applying a first adhesive layer to the first surface of the lead plate and affixing the base plate to the first adhesive layer; as well as, applying a second adhesive layer to the second surface of the lead plate and affixing a polymer coating material to the second adhesive layer. In one embodiment of the present invention, the step of affixing a polymer coating material to the second adhesive layer includes the steps of: applying a liquid polymer to the second adhesive layer; exposing the liquid polymer to an elevated pressure of between 80.0 and 90.0 psi; and hardening the liquid polymer to form a solid polymer

Further aspects or embodiments of the present invention will become apparent from the ensuing description which is given by way of example only.

### BRIEF DESCRIPTION OF THE DRAWINGS

FIG. 1 is a cross sectional front view of a laminated lead composite element according to one embodiment of the present invention.

FIG. 2 is a flow chart of a method of manufacturing the laminated lead composite element according to one embodiment of the present invention.

FIG. 3 is a top plan view of base plate for use in one embodiment of a laminated lead composite element of the present invention;

FIG. 4 is a top plan view of base plate of FIG. 3 receiving a volume of epoxy;

FIG. 5 is a top plan view of a lead plate received on the base plate of FIG. 3;

FIG. 6 is a top plan view of an adhesive coating applied to the lead plate of FIG. 5 surrounded by tape;

FIG. 7 is a top plan view of the adhesive coating applied to the lead plate of FIG. 4 with the surrounding tape removed;

FIG. 8 is a top plan view of a first half of a mold configured to receive the base plate of FIG. 3;

FIG. 9 is a top plan view of a second half of a mold configured to engage a volume of polymer coating material deposited onto a surface of the lead plate of FIG. 7;

FIG. 10 is a top plan view of the first half of the mold of FIG. 8 receiving the base plate of FIG. 3 therein;

FIG. 11 is a bottom plan view of the first half of the mold of FIG. 7 with screws engaging the base plate of FIG. 3;

FIG. 12 is a top plan view of the first half of the mold of FIG. 8 receiving a volume of polymer coating material on top of the lead plate;

FIG. 13 is a top plan view of the first half of the mold of FIG. 10 having received a volume of polymer coating material on top of the lead plate;

FIG. 14 is a top plan view of the first and second halves of the mold of FIG. 10 in a closed orientation;

FIG. 15 is an end view of the first and second halves of the mold of FIG. 14 located in a pressure chamber

FIG. 16 is a top plan view of the laminated lead composite element according to one embodiment of the present invention having an excess of polymer coating material;

FIG. 17 is a bottom plan view of the laminated lead composite element according to one embodiment of the present invention having an excess of polymer coating material; and

FIG. 18 is top plan view of the laminated lead composite element according to one embodiment of the present invention.

### DETAILED DESCRIPTION OF THE DRAWINGS

### Laminated Lead Composite Element

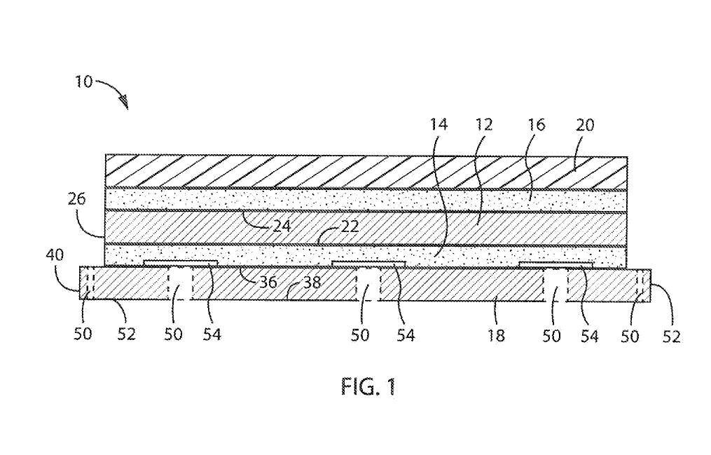

Referring now to FIGS. 1-18, and specifically FIG. 1, there is shown one embodiment of the laminated lead composite element 10 according to the present invention. In FIG. 1, there is generally shown a laminated lead composite element 10 comprising a lead blank 12 laminated or coated with a first adhesive coating or layer 14, and a second adhesive layer or coating 16. The lead blank 12 is positioned and affixed between a base plate 18 on one side and a polymer coating material 20 on an opposing side.

The lead blank 12 has a first surface 22, which receives the first adhesive coating 14 thereon and a second surface 24, opposite the first surface 22, which receives the second adhesive coating. The lead blank 12 may have a thickness or width 26, between the first and second surfaces 22, 24 sufficient for absorbing and/or scattering electromagnetic radiation, such as x-ray radiation. In one embodiment, the width 26 of the lead blank 12 is approximately between 0.01 inches and 0.1 inches, and representatively may be approximately 0.038 inches. However, any other width 26 of the lead blank 12 sufficient to absorb and/or scatter the quantity of electromagnetic radiation specified by a particular radiographic application is considered within the scope of this invention. The general shape of the lead blank 12 may also vary according to the radiographic application in which it is used. That is to say that the lead 12 blank may be smaller, larger or equal to the size and shape of the base plate 18 and/or polymer coasting material 20. However, as shown in FIGS. 1, and 3-18, in one embodiment the lead blank 12 may be approximately rectangular in shape, having first, second, third and forth edges 28, 30, 32, 34, respectively, defining the area of the lead blank 12.

The lead blank 12 is laminated or coated with one or more adhesive coatings 14, 16. In one embodiment of the present invention, as is shown in FIG. 1, the first adhesive coating 14 is applied to the first surface 22 of the lead blank 12 while the second adhesive coating 16 is applied to the second surface 24 of the lead blank 12. In alternative embodiments of the present invention, the same adhesive coating 14 or 16, respectively, may be applied to either a single surface 22, 24 of the lead blank 12; or alternatively, the same adhesive coating 14 or 16, respectively, may be applied to both the first and second surfaces 22, 24 of the lead blank 12.

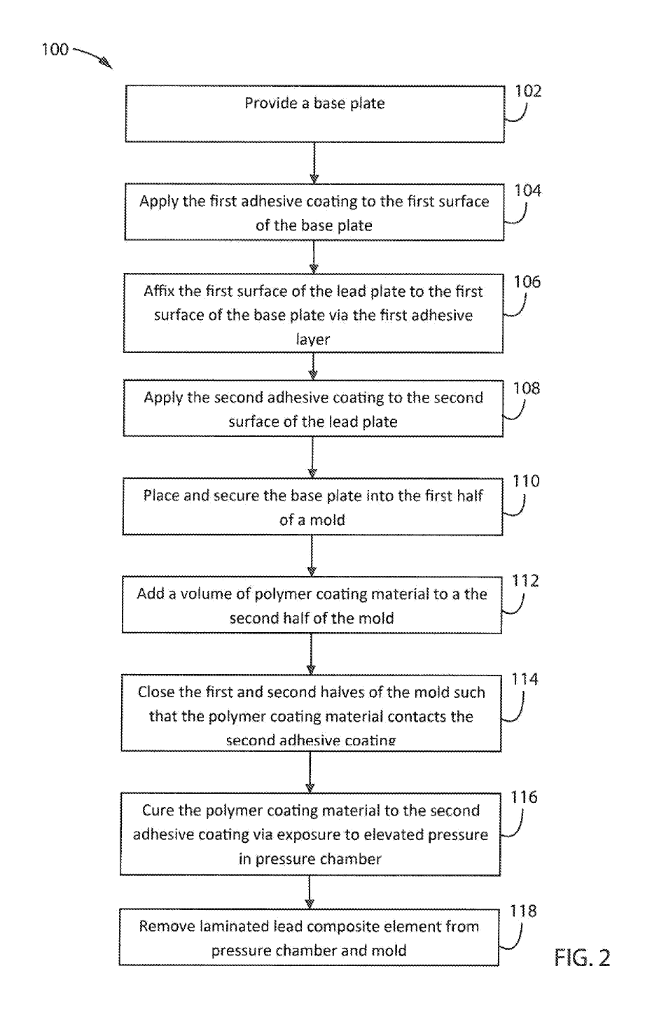

In a first embodiment, the first adhesive coating 14 may be a pressure sensitive adhesive plastic coating applied to an acrylic sheet. The first adhesive coating 14 may be adhesively applied and affixed to the first surface 22 of the lead blank 12. One example of such a first adhesive coating 14 is identified as product number 9469 manufactured by 3M® of St. Paul, Minn. In this embodiment, once the pressure sensitive adhesive plastic coating has been adhered to the first surface 22 of the lead blank 12, the adhesive located on the opposing side of the plastic coating may be exposed, typically by peeling off a protective covering from the pressure sensitive adhesive plastic coating to expose a second adhesive surface of the coating that will be adhered to the base plate 18. In an alternative embodiment, the adhesive coating 14 may be a glue, epoxy or adhesive transfer tape rather than a pressure sensitive adhesive plastic coating. The epoxy may be applied to either the first surface 22 of the lead, or to the base plate 18, as shown in FIG. 2 and described in further detail below before the lead plate 12 and base plate 18 are joined.

Still referencing FIG. 1, the base plate 18 is shown, having a first surface 36 and an opposing second surface 38, with a width 40 located between the surfaces 36, 38. The first surface 36 is configured to be adhered to the first surface 22 of the lead plate 12. In one embodiment, the base plate 18 is formed from aluminium and has a width 40 sufficient to support the lead blank 12, any dimension of which is considered within the scope of this invention, as are alternative metal and/or non metal materials. As with the lead plate 12, the general shape of the base plate 18 may also vary according to the radiographic application in which it is used. However, as shown in FIGS. 1 and 3-16, and specifically FIG. 1, in one embodiment the base plate 18 may be approximately rectangular in shape, having first, second, third and forth edges 42, 44, 46, 48, respectively, defining the area of the base plate 18. Typically, the size of the base plate 18 will be equal to or grater than the size of the lead plate 12, such that the entire first surface 22 of the lead plate 12 engages the first surface 36 of the base plate 18. One or more mounting structures, such as apertures or holes 50 and/or outwardly extending tabs 52 may also be located in the base plate 18. The apertures or holes 50 may extend from the second surface 38 through a length of width 40. As shown in FIG. 1, the mounting holes 50 may also extend through the entire width 40 and into the first surface 36; in which case, covers 54 may be placed over the exposed ends of the mounting holes 50 on the first surface 36, to prevent the adhesive coating 14 from entering the mounting holes 48. The mounting holes 50 may be threaded to allow the base plate 18, and thereby the laminated lead composite element 10, to be secured to a medical device or other radiographic application in which it is configured to be used.

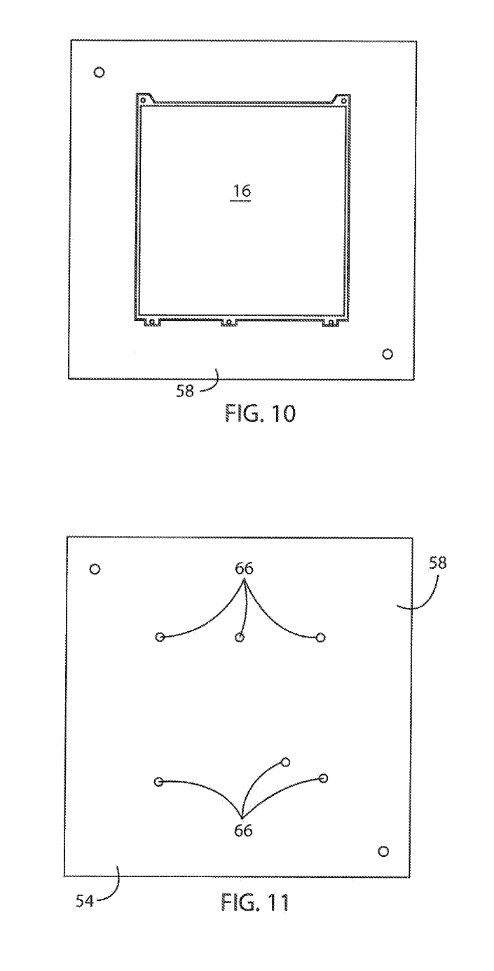

After the first surface 22 of the lead plate 12 has been affixed to the first surface 36 of the base plate 16, a polymer coating material 20 is adhered to the exposed second surface 24 of the lead plate 12. Application of the polymer coating material 20 to the lead plate 12 may require the use of an adhesive 16 deposited between the lead plate 12 and the polymer coating material 20, as shown in FIGS. 1 and 10 and described in further detail below. In one embodiment, the adhesive 18 may be an aerosolized adhesive such as Chemlok® 213, as manufactured by the Lord Corporation of Cary, N.C. and may be diluted or thinned at a ratio of 1:1 with a thinner such as Chemlok® 248, which is also as manufactured by the Lord Corporation of Cary, N.C. The second adhesive layer 16, such as Chemlok® 213, may be an adhesive that is particularly well suited for adhering polymers to metallic materials. In one embodiment of the present invention, the second adhesive layer 16 may comprise approximately 50.0 to 60.0 percent by weight methyl ethyl ketone, i.e., butanone, and approximately 20.0 to 30.0 percent by weight epoxy resin. Once the adhesive 16 has been evenly applied to the second surface 24 of the lead plate 12 it is allowed to dry. The drying time will vary depending upon the characteristics of the adhesive 16, however, in one embodiment the drying time may be approximately 1 to 2 hours. The polymer coating material 20 is then affixed onto the dry adhesive 16, which is located on the second surface 24 of the lead plate 12.

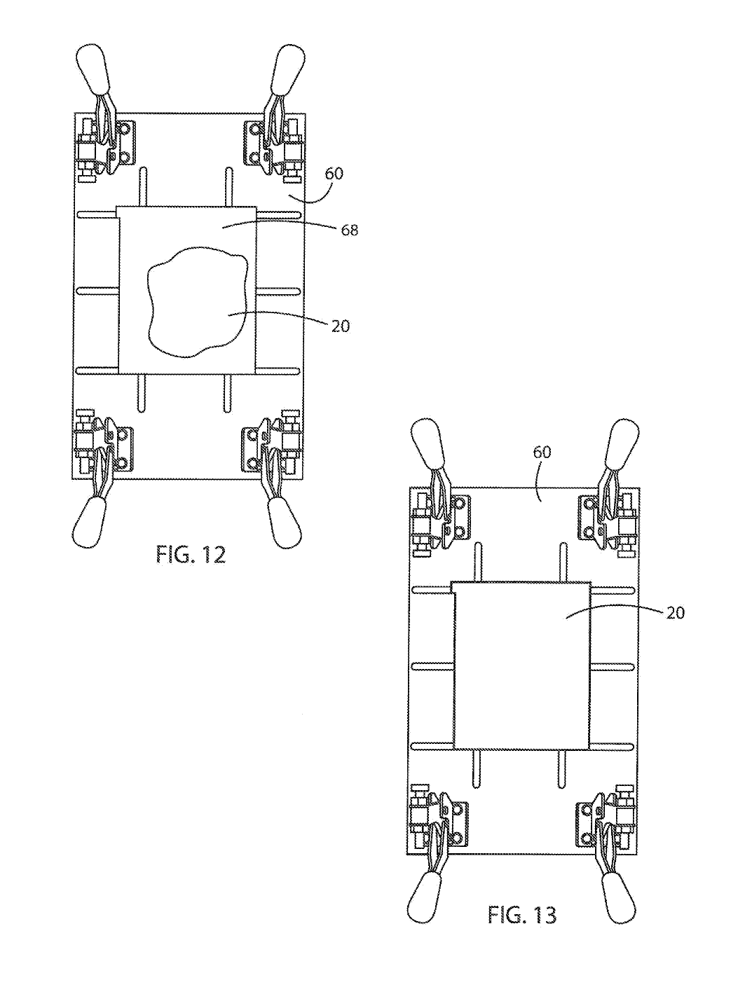

Still referring to FIG. 1, and also FIGS. 12-18, the polymer coating material 20 is applied in a liquid form onto the second surface 24 of the lead plate 12. In one embodiment, the polymer coating material 20 is a urethane material such as polyurethane elastomer. As shown in FIG. 12, the polymer coating material 20 is applied to the lead plate 12 in liquid form, however it is also considered within the scope of this invention that the polymer coating material 18 may be spayed or otherwise applied to the second surface 24 of the lead plate 12. Once the polymer coating material 20 has been applied to the lead plate 12, as shown in FIG. 15, a mold 56, which may include both upper and lower opposing portions 58, 60, is closed about the lead plate 12 and its liquid polymer coating material 20. The entire mold 56 and its contents is then placed into a pressure chamber 62 at approximately 80-90 psi for a duration of approximately 1.75 hours, during which time the liquid polymer coating material 20 cures into a hardened yet resilient polymer coating material 20 that is affixed to the second surface 24 of the lead plate 12. In an alternative embodiment, rather than individually applying laminate layers, the entire laminated lead composite element 10 may be enclosed within a surrounding plastic coating.

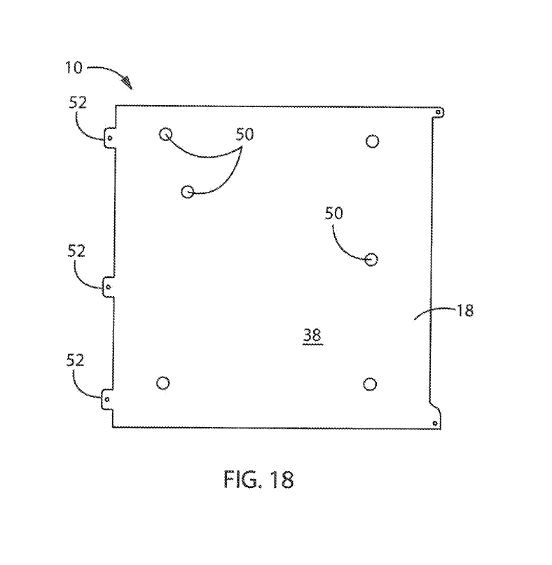

Once the pressure chamber has been depressurized, the mold 56 may be removed and the laminated lead composite element 10 released therefrom. Any excess polymer coating material 20 may be removed from the laminated lead composite element 10, as shown in FIG. 17, before the laminated lead composite element 10 is completed, as shown in FIG. 18.

### Method of Making a Laminated Lead Composite Element

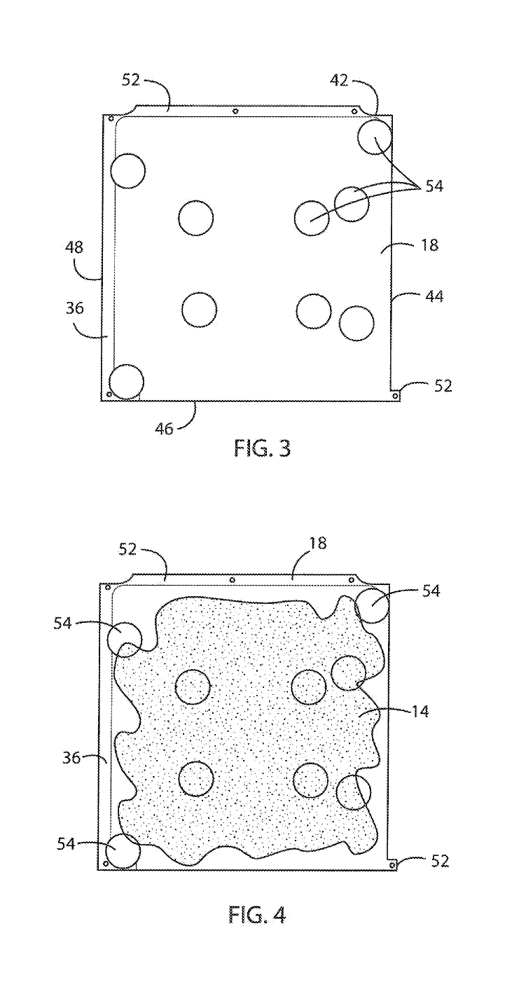

Turning now to the flow chart shown in FIG. 2 and the representative step wise drawings of FIGS. 3-18, a method 100 of making a laminated lead composite element 10 in accordance with one embodiment will be described.

Initially, in the first box 102 and as shown in FIG. 3, a base plate 18 is provided including various mounting structures such as holes 50 that extend there through and tabs 52 that outwardly extend from the sides 42, 44, 46, 48 of the base plate 18. If one or more mounting holes 50 are present in the base plate 18 and extend fully through the entire width 40 of the base plate 18, the exposed ends of the mounting holes 50 at the first surface 36 may be overlayed by small covers 54 to prevent the adhesive coating 14 from entering the mounting holes 48.

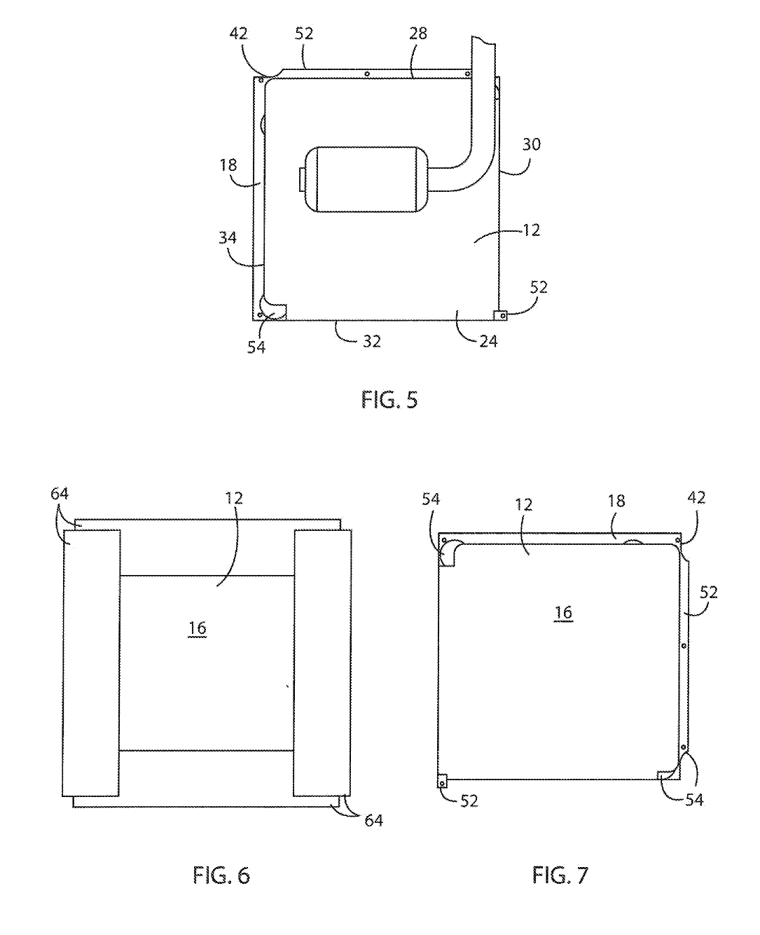

Turning now to box 104, as shown in FIG. 4, the first adhesive coating 14 may be applied directly to the first surface 36 of the base plate 18, and specifically within the area equal to the size of the first surface 22 of the lead plate 12. If the first adhesive coating 14 is a liquid adhesive, such as an epoxy resin, it may be spread evenly on the base plate 18 to prevent the formation of bubbles or delamination between the lead plate 12 and the base plate 18. Then, at box 106, as shown in FIG. 5, the first surface 22 of the lead plate 12 is placed onto the first surface 36 of the base plate 18, where both plates 12, 18 become adhesively bound to one another via the first adhesive layer or coating 14. As seen in FIG. 5, a roller may be used to provide a downward force onto the lead plate, and remove entrapped air bubbles from the first adhesive layer 14. Alternatively, as described above, the first surface 22 of the lead plate 12 may receive the adhesive coating 14, in which case the adhesive coating 14 may be a pressure sensitive adhesive plastic coating applied to an acrylic sheet. One example of such an adhesive coating 14 is identified as product number 9469 manufactured by 3M®. In this embodiment, once the pressure sensitive adhesive plastic coating has been adhered to the surface 22 of the lead blank 12, the opposing adhesive may be exposed by means of peeling off a protective covering from the pressure sensitive adhesive plastic coating to expose a second adhesive surface of the coating that will be adhered to the base plate 18. Once the plates 12, 18 are joined, the first adhesive coating 14, for example either epoxy or pressure sensitive adhesive, is allowed to cure for a period of many hours, e.g. 24 hours.

After the adhesive coating 14 has cured and the lead plate 12 is adhesively bound to the base plate 16, the edges 28, 30, 32, 34 of the lead blank 12 are inspected to locate any area in which the lead plate 12 extends beyond the edges 40, 42, 44, 46 of the base plate 16. If such overhang is identified, the lead plate 12 is trimmed to eliminate such overhang.

Turning now box 108, as shown in FIG. 6, tape 64 is applied along the edges 28, 30, 32, 34 of the lead blank 12, such that only the exposed second surface 24 of the lead plate 12 is exposed. The second adhesive layer 16 is then applied to the exposed second surface 24 of the lead plate 12 as to promote bonding with the subsequently applied polymer coating material 20. As was described in detail above, in one embodiment, the second adhesive layer 16 may be an aerosolized adhesive such as Chemlok® 213, as manufactured by the Lord Corporation, and may be diluted or thinned at a ratio of 1:1 with a thinner such as Chemlok® 248, which is also as manufactured by the Lord Corporation.

Turning now to FIG. 7, tape 64 is removed from along the edges 28, 30, 32, 34 of the lead blank 12, to reveal portions of the base plate 18 there under. Once the tape is removed, the second adhesive layer 16 on the second surface 22 of the lead plate 12 is allowed to dry, approximately 1-2 hours, or until dry to the touch.

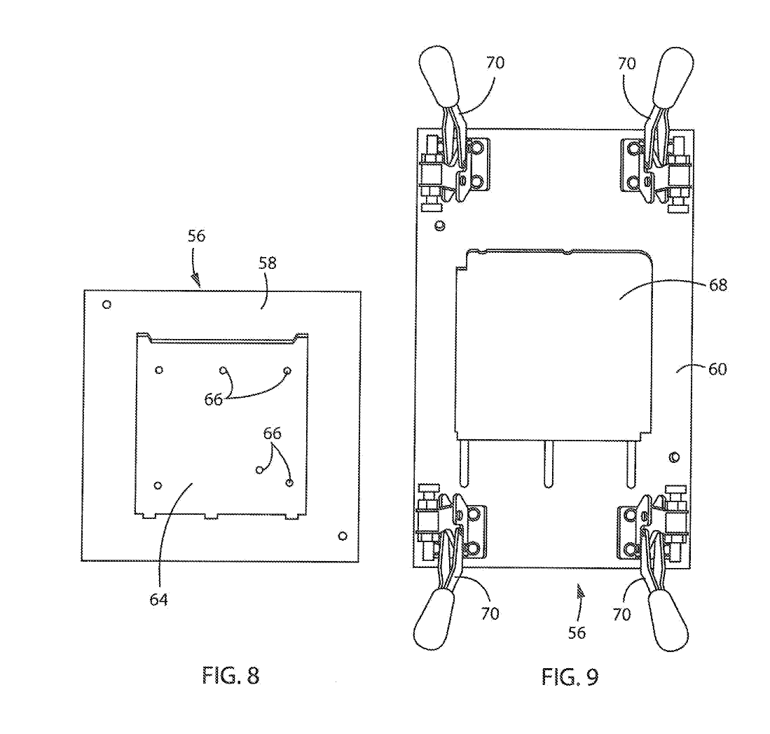

A mold 56 is then provided for use in the subsequent application of the polymer coating material 20. Turning now to FIGS. 8 and 9 respectively the mold 56 is shown separated into a first half 58 and a second half 60, which mate together to form an enclosure for retaining the laminated lead composite element 10 therein. The first half 58 of the mold 56, as shown in FIG. 8, includes a shallow recess 64 that is configured to receive the second surface 38 of the base plate 18 therein. The first half 58 of the mold 56 also includes one or more holes 66, which correspond to the mounting holes 50 within the base plate. Similarly, the second half 60 of the mold 56, as is shown in FIG. 9, also includes a recess 68, which corresponds to the area in which the polymer coating material 20 will be located. The second half 60 of the mold 56 is also shown having a plurality of clamps 70, which secure the first and second halves 58, 60 of the mold 56 together.

Turning now to box 110, as shown in FIGS. 10 and 11, the base plate 18 is placed into the first half 58 of the mold 56, after the second adhesive layer 16 is dry. The mold 56 may be pretreated with a light coating of releasing agent, such as a silicon based releasing agent, prior to placing the base plate 18 into the first half 58 of a mold 56. As shown in FIG. 10, the base plate 18 is placed with the second surface 38 downwards into the recess 64. Once the second surface 38 of the base plate 16 is placed downwards into the first half 58 of the mold 56, the base plate 18 is secured within the mold 56 by engaging screws through the holes 66 in the mold 56 and into the mounting holes 48 in the base plate 18, as seen in FIG. 11. With the base plate 18 securely retained within the first half 58 of the mold 56, the exposed second surface 24 of the lead plate 12, with its second adhesive layer 18 thereon, is oriented upwards and contained within a shallow recess 64 in the mold 56. The recess 58 defines the area into which the polymer coating material 18 will then be applied; and, corresponds to a recess 60 located in the second half 56 of the mold 52, which will subsequently be placed onto of the first half 54, shown in FIG. 7.

Turning now to box 112, as shown in FIG. 12, the polymer coating material 20 is then applied in a liquid form onto the recess 68 in the corresponding second half 60 of the mold 56. In one embodiment, the polymer coating material 20 is a urethane material such as polyurethane elastomer. As shown in FIG. 12, the polymer coating material 20 is applied into the recess 68 in liquid form and spread over the entire surface of the recess 68, and then spread evenly in FIG. 13.

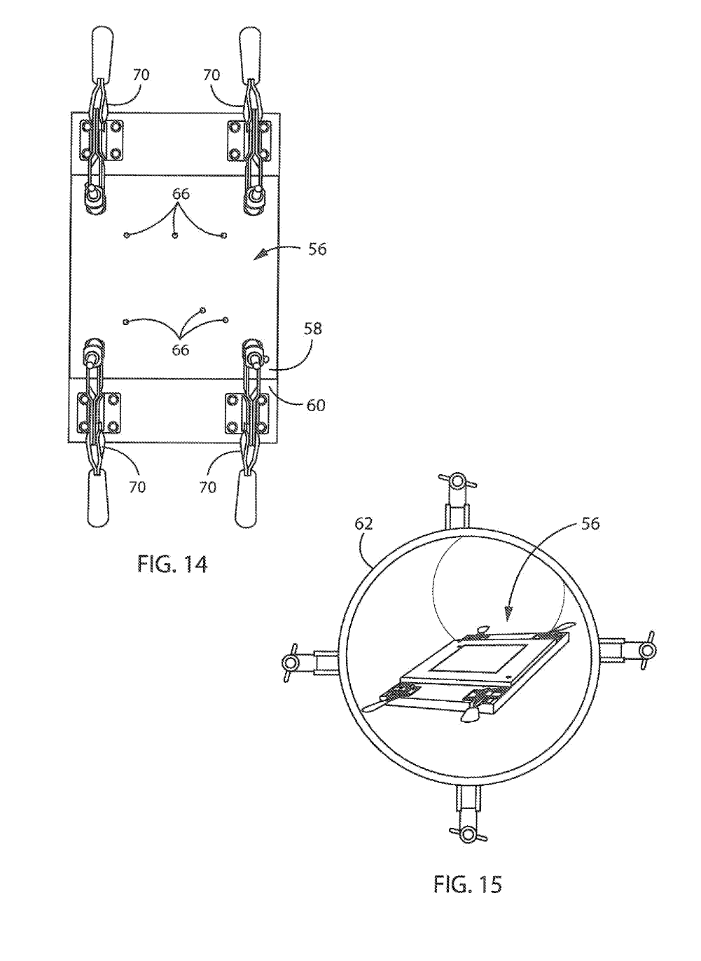

Turning now to box 114, as shown in FIG. 14, once the polymer coating material 20 has been applied, the first half 58 of the mold 56, including the lead plate 12, base plate 18, and first and second adhesive layers 14, 16, which are secured thereto, are inverted and placed over the second half 60 of the mold 56. As such, the first and second halves 58, 60 of the mold 56 are closed with the polymer coating material 20 contacting the second adhesive layer 18 while within the mold. The clamps 70 may then be engaged to secure the mold 56 in this closed orientation.

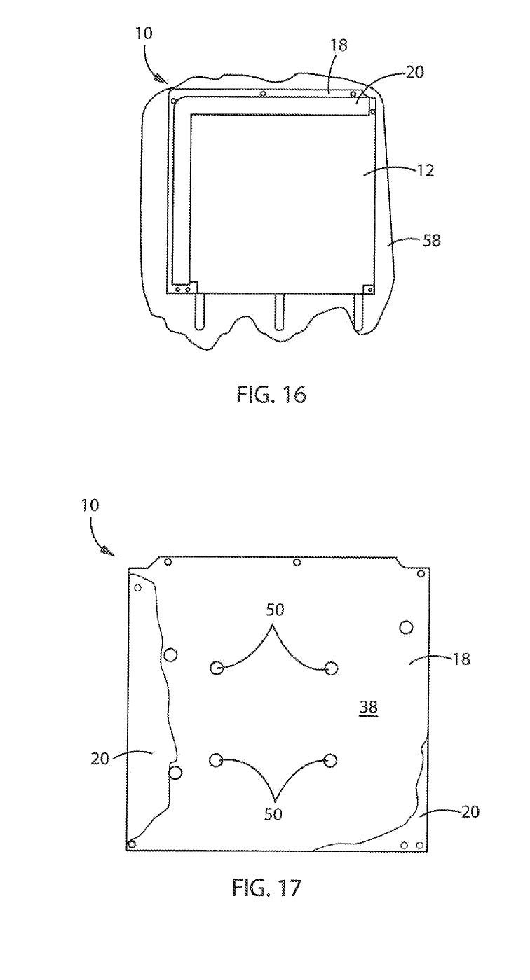

Turning now to box 116, as shown in FIG. 15, the entire mold 56 and its contents are then placed into a pressure chamber 62 at approximately 80-90 psi for a duration of approximately 1.75 hours, during which time the liquid polymer coating material 20 cures into a hardened yet resilient polymer coating material 20 that is affixed to the second surface 24 of the lead plate 12 via the second adhesive layer 16. Once removed from the pressure chamber 62 and mold 56 at box 118, any excess polymer coating material 20, as shown in FIGS. 16 and 17 may be removed until the finalized laminated lead composite element 10 remains, as seen in FIG. 18.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

We claim:

1. A lead composite for electromagnetic radiation shielding, the composite comprising:
a lead plate having a first and second surface, wherein at least one of the first and second surfaces of the lead plate is a laminated surface;
a base plate affixed to the first surface of the lead plate; and
a polymer coating material affixed to the second surface of the lead plate.

2. The lead composite of claim 1, further comprising a first adhesive layer disposed between the first surface of the lead plate and the base plate.

3. The lead composite of claim 2, wherein the first adhesive layer comprises a resin.

4. The lead composite of claim 3, wherein the resin of first adhesive layer is an epoxy resin.

5. The lead composite of claim 2, further comprising a second adhesive layer disposed between the second surface of the lead plate and the polymer coating material.

6. The lead composite of claim 5, wherein the second adhesive layer comprises butanone.

7. The lead composite of claim 5, wherein the second adhesive layer comprises a resin.

8. The lead composite of claim 7, wherein the resin of second adhesive layer is an epoxy resin.

9. The lead composite of claim 1, wherein the base plate comprising one or more mounting structures configured to support the lead composite in affixed position.

10. The lead composite of claim 1, wherein the lead plate has a thickness of between 0.01 inches and 0.1 inches.

11. A method of making a lead composite for electromagnetic radiation shielding comprising the steps of:
laminating at least one of a first and second surface of a lead plate;
affixing the first surface of the lead plate to a base plate; and
affixing a polymer coating material to the second surface of the lead plate.

12. The method of claim 11, wherein the step of affixing the first surface of the lead plate to the base plate includes the steps of:
applying a first adhesive layer to the first surface of the lead plate; and
affixing the base to the first adhesive layer.

13. The method of claim 12, wherein the first adhesive layer comprises an epoxy resin.

14. The method of claim 11, wherein the step of affixing a polymer coating material to the second surface of the lead plate includes the steps of:
applying a second adhesive layer to the first surface of the lead plate; and
affixing a polymer coating material to the second adhesive layer.

15. The method of claim 14, wherein the first adhesive layer comprises butanone.

16. The method of claim 14, wherein the first adhesive layer comprises a resin.

17. The method of claim 14, wherein the step of affixing a polymer coating material to the second adhesive layer includes the steps of:
applying a liquid polymer to the second adhesive layer;
exposing the liquid polymer to an elevated pressure of between 80.0 and 90.0 psi; and
hardening the liquid polymer to form a solid polymer

18. The method of claim 14, wherein the polymer coating material comprises a polyurethane elastomer.

19. A lead composite for electromagnetic radiation shielding, the composite comprising:
a lead plate having a first surface, a second surface, and a thickness of between 0.01 inches and 0.1 inches;
a first adhesive layer disposed on the first surface of the lead plate;
a base plate comprising one or more mounting structures, wherein the base plate is affixed to the first adhesive layer;
a second adhesive layer disposed on the second surface of the lead plate; and
a polymer coating material comprising a polyurethane elastomer affixed to the second adhesive layer.

20. The lead composite of claim 19 configured to engage an electromagnetic radiation emitting device at the one or more mounting structures.
